(19) United States
(12) Patent Application Publication
(10) Pub. No.: US 2017/0045214 A1
(43) Pub. Date: Feb. 16, 2017

(54) IMPROVED LED LAMPS AND LUMINAIRES

(71) Applicant: Gooee Limited, St Albans (GB)

(72) Inventor: Andrew Johnson, Klosters (CH)

(73) Assignee: Gooee Limited, St Albans (GB)

(21) Appl. No.: 15/306,733

(22) PCT Filed: Apr. 26, 2015
(86) PCT No.: PCT/IB2015/053034

§ 371 Date: Oct. 25, 2016

(30) Foreign Application Priority Data
Apr. 25, 2014 (GB) 1407301.9

(51) Int. Cl. F21V 29/77; F21S 8/02; F21V 25/12; F21V 3/04; F21V 5/04; F21V 21/26; F21V 23/00; F21V 29/89

(52) U.S. Cl. CPC F21V 29/77; F21V 23/005; F21S 8/026; F21V 29/89; F21V 3/0418; F21V 5/04; F21V 21/26; F21V 25/12; F21Y 2115/10

(57) ABSTRACT

An LED downlight lighting module is provided including an LED module having one or more single LEDs on a first printed circuit board, a heat sink, and a second printed circuit board. In an embodiment, the first printed circuit board is in good thermal contact with the heat sink such that heat from the LEDs is dissipated through the heat sink. In an embodiment, the second printed circuit board is adapted to accommodate a power and control circuitry for the LEDs, and is thermally insulated from the heat sink and from the first printed circuit board, and thus from the LED module. According to an aspect, the LEDs serve as the principal heat generating component on the printed circuit board, thus helping to increase the light output from the LEDs and/or increase the lifespan of the LED downlight lighting module.

### FIELD OF INVENTION

The present invention relates to LED light engines, LED lamps and LED luminaires. It is particularly applicable to LED lamps and LED products containing an on board driver and/or on board control integrated circuits.

### BACKGROUND TO THE INVENTION

LED luminaires and lamps are increasing in popularity and it is expected that this popularity will continue to increase in the future as their light output improves both quantitatively and qualitatively. With lighting units that include LED modules it is important to prevent overheating of the LED module, because overheating can seriously reduce the service life of the lighting element, resulting in premature failure of the LED lamp/luminaire.

In many currently available LED lamps and luminaires one or more LED modules together with their associated driver(s) and other control components are mounted together on the same printed circuit board, generally a metal printed circuit board (MCPCB), often made of aluminium, and this is in close thermal contact with a heat sink. This arrangement allows for the rapid transfer of heat away from the LED module(s).

As LED's enter mainstream lighting applications, consumers expect their operation to mimic traditional lighting units such as incandescent bulbs and fluorescent tubes. This includes being able to dim LEDs and being able to control LEDs remotely from hand held devices such as smart phones and tablets by way of appropriately designed Apps. Furthermore, a new generation of ‘smart’ light fitting luminaires is starting to become available that contain detectors that sense information about their local environment and which communicate this information to a processor. These light fitting luminaires are a way of collecting data about the environment in which they are situated. This overcomes the problems associated with dedicated sensors in a particular location, such as a room thermostat which only covers a limited area, because a building or house will contain many light fitting luminaires, each capable of gathering data. The data gathered by these luminaires thus has a much higher granularity than data collected by other approaches, and is therefore more useful.

These various advances inevitably require additional processing power, often by way of control integrated circuits (ICs) with increased functionality, including data storage capacity and wireless communication functionally. These can all produce significant amounts of heat, in addition to the heat produced by the LED, leading to a requirement for larger heat sinks in order to keep the temperature of the LED MCPCB down to acceptable levels.

It is an object of the present invention to overcome or mitigate some or all of the problems outlined above.

### SUMMARY OF THE INVENTION

According to a first aspect of the present invention there is provided an LED lighting module according to claim 1. For example there is provided an LED lighting module comprising:—
(i) an LED module comprising one or more single LEDs on a first printed circuit board (PCB);
(ii) a heat sink, the first printed circuit board (PCB) being in good thermal contact with the heat sink such that heat from the LED(s) is dissipated through the heat sink;
(iii) a second printed circuit board adapted to accommodate the power and control circuitry for the LED(s);
   wherein the second printed circuit board is thermally insulated from both the heat sink and from the first printed circuit board and thus from the LED module.

By having the LED as the principal heat generating component on the LED PCB, and by separating the LED PCB, and thus the heat generated by the LED in use, from the control circuitry and components required to power and control the LED and the heat that they produce, and by mounting those non-LED components on one or more separate PCBs, it is possible to increase the light output from the LED and/or increase the lifespan of the LED lighting module. This is particularly the case when the LED lighting module is used in an application where there is reduced air circulation, such as in enclosed or fire rated luminaires. For example, by using the present invention it is possible to achieve a life of 25,000 hours or more at L70 (70% lumen maintenance). This assumes that there is some free air space around the bulb/luminaire. It will be appreciated that if there is restricted air flow around the LED lighting module, such as when it or the luminaire it is in is covered by insulation material, then this life expectancy will be reduced somewhat.

The thermal insulation between the first PCB and the second PCB can take a variety of forms. It could, for example, take the form of a sheet or layer of insulation material, a potting compound if the second PCB is in an enclosed space, or in the form of an air gap between the first and second PCBs with or without additional insulating materials.

Preferably the second printed circuit board further comprises dimming circuitry components for controlling the brightness of the LED module.

Preferably the first PCB comprises a metal PCB (MCPCB) and more preferably the metal PCB includes aluminium. Aluminium PCBs, or PCBs made from other metals with a high heat transfer coefficient, transfer heat away from the LED and into the heat sink most efficiently.

Preferably a thermally conductive interface is provided between the first PCB and the heat sink. Suitable thermally conductive interfaces are, by way of example, thermally conductive grease, thermally conducting pads, graphite foil, or thermally conductive acrylic film.

Preferably the second PCB includes a glass-reinforced epoxy laminate sheet, such as FR-4

In a further preferred embodiment the second PCB further includes or comprises a metal PCB. This arrangement is particularly effective when the control circuitry includes an Integrated Circuit (IC) that produces a significant amount of heat that warrants it being mounted on a separate metal PCB (MCPCB), attached in some way to the second PCB to form a second PCB assembly. Separating the main heat producing components on the second PCB onto a separate metal core PCB brings significant advantages in controlling the heat produced during prolonged operation. Preferably this metal PCB includes aluminium.

Preferably the heat sink comprises a body formed from material including thermally conductive material. In this way the lamp body of the LED lighting module is also a heat sink, which is preferably formed from or includes aluminium.

Advantageously the lamp body takes the form of a substantially hollow substantially frustoconical shape, closed at or near its narrower end by a rear wall having a front face and a rear face. This includes the shape of a conventional GU10 lamp body.

Preferably the front face of the rear wall is substantially planar. This is the region where the LED PCB is in close thermal contact with the rear wall of the heat sink body once assembled and keeping this region planar improves heat transfer.

Preferably the heat sink body incorporates a plurality of fins to aid convection of heat away from the heat sink and preferably some or all of the fins are located inside the body.

Preferably the thermal insulation material comprises a disc of plastics material that sits against the rear face of the rear wall of the heat sink body.

Preferably the LED lighting module further comprises a lamp cap fitting, which is preferably a GU10 is fitting. This enables the second printed circuit board to be accommodated within the GU10 cap fitting.

In a particularly preferred embodiment the thermal insulation material includes a potting compound which surrounds the second PCB, or second combination of PCBs to encapsulate it and thermally isolate it from both the heat sink and the first PBC.

Preferably the lighting module further comprises a lens, a lens holder, and a lens cover.

The present invention extends to include light fittings incorporating an LED lighting module as described.

### BRIEF DESCRIPTION OF THE DRAWINGS

The invention will now be described, by way of example only, in relation to the accompanying figures wherein:

FIGS. 1A and 1B illustrate exploded views of a non-dimmable lighting module with the control components on a single second PCB;

FIG. 2 illustrates an exploded view of a dimmable LED lighting module with the dimming and control components on a second PCB incorporating a supplementary PCB;

FIGS. 3A and 3B illustrate exploded views of a non-dimmable LED lighting module in which the control components are distributed between two PCBs inside a GU10 cap;

FIGS. 4A and 4B illustrate exploded views of a dimmable version of the LED lighting module shown in FIGS. 3A and 3B;

FIG. 5 shows a sectional view of a downlight design in accordance with a second embodiment of the present invention; and

FIG. 6 shows an exploded component view of the downlight design of FIG. 5.

### DESCRIPTION OF THE PREFERRED EMBODIMENTS

In the context of the present invention the term ‘LED lighting module’ refers to a functioning LED light engine and it associated control circuitry, such as a power supply, dimmer, and/or control IC or electronics. The term ‘LED module’ refers to one or more LED light engines mounted on a suitable PCB, with or without any associated control circuitry.

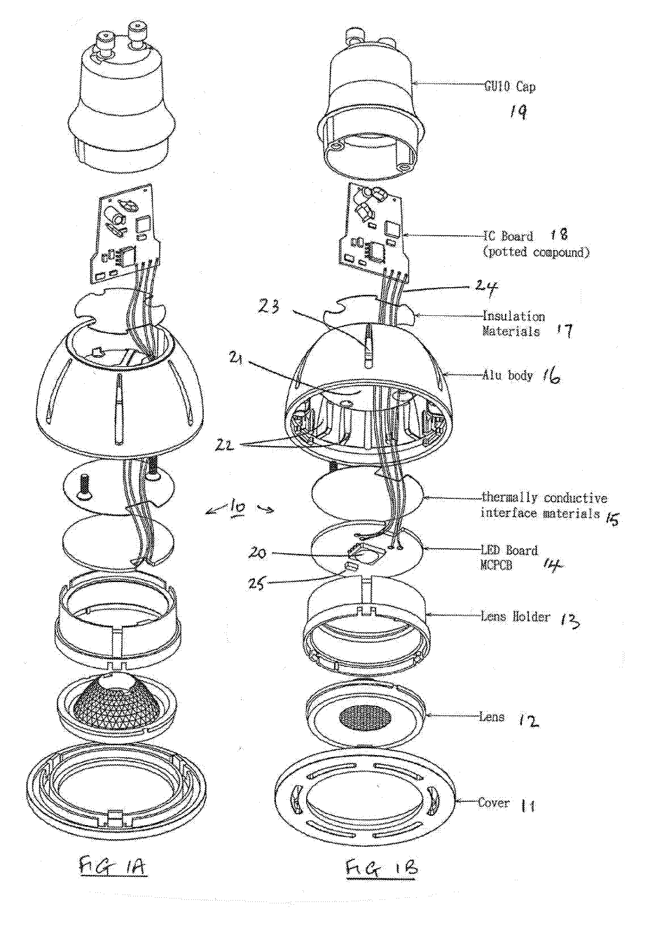

Referring to FIGS. 1A and 1B, these illustrate exploded diagram views of an LED lighting module according to the present invention. In this example the invention is expressed as a GU10 lamp 10. The lamp 10 comprises a GU10 cap 19, an aluminium lamp body 16 which acts also as a heat sink, a lens holder 13, a lens 12 and a cover 11. These components are similar to those components found in an existing GU10 lamp. The arrangement and positioning of the LED module and the associated power management and power conversion, driver, dimming, control and sensing components within the LED lighting module set this invention apart from known lighting modules. More specifically, an LED board 14 is provided on which is mounted an LED 20. Other electronic components are mounted elsewhere, away from the LED PCB, with the possible exception of a diode 25 to protect the LED from reverse breakdown voltage. The LED PCB and thus the LED 20 is in good thermal contact with the inner side of the rear end wall 21 of the aluminium body. This good thermal contact may be enhanced by means of thermally conductive interface materials such as thermally conductive grease, a thermally conducting pad or pads, graphite foil, thermally conductive acrylic film, or thermally conductive nano composites or polymers. It will be understood that any suitable thermally conductive material can be used for this purpose. The front face of the rear end wall 21 of the body 16 is substantially planar to facilitate heat transfer over the whole surface area of the back of the LED PCB 14.

In terms of electrical/electronic components generating a heat load, the LED 20 is the only such component mounted on the LED PCB 14, and thus only heat generated by the LED is transmitted to, and dissipated by, the aluminium lamp body 16. A plurality of internally directed heat fins 22 are incorporated in the body 16 to aid in the heat dissipation process.

A plurality of apertures or slits 23 are also provided in the aluminium body designed to aid air circulation and thus heat dissipation.

It will be appreciated that, while it is advantageous to have a plurality of fins or slits to help dissipate heat, one large fin and/or slit could suffice.

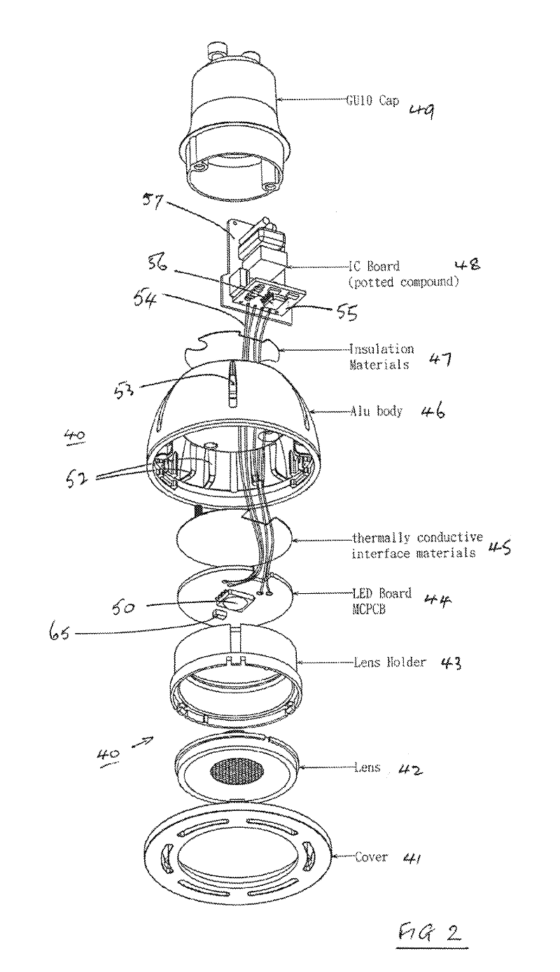

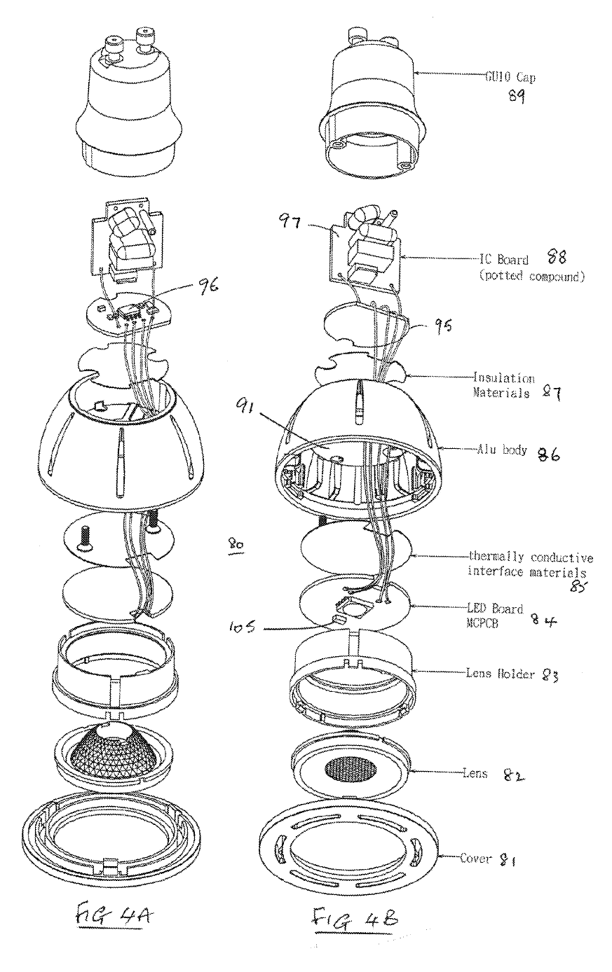

The other electrical/electronic components required for operation of the LED lighting module are located on a separate, second PCB 18 which in this example is sized and shaped to fit within the GU10 cap 19. These components include, but are not limited to, driver components, power management and power conversion components, and control components. Where a dimming function is provided the dimming components would also be incorporated into this board, or on a further separate PCB within the GU10 cap (see FIGS. 2 and 4 and associated description below).

This second PCB 18 is preferably made from a glass-reinforced epoxy laminate sheet such as FR-4 and is encapsulated within the GU10 cap 19 with a potting compound, further isolating the heat produced by the components on this second PCB from the heat sink and thus from the LED itself. To improve this thermal isolation, a layer of insulating material 17 may optionally be placed over the outer side of the rear end wall 21 of the aluminium body, being the side facing towards the GU10 cap 19. Any suitable insulation material may be used for this purpose but a sheet of plastics material is a cost effective solution.

Although the lamp body 16 has been described as being made of aluminium, any thermally conductive material could be used, either a metal or a non-metal. Aluminium is usually the preferred choice because of its high thermal conductivity, reasonable cost, and ease of moulding or working. The first MCPCP 14 and the second IC Board PCB 18 are connected by wires 24 in a conventional manner. In this example four wires are provided because the LED and driver is of a three-stage design, with 3 negative poles and 1 positive pole. It will be appreciated that in the arrangement described in this example, only heat generated by the LED has to be dissipated by the heat sink. As a result of this the LED may be driven harder in order to increase its light output, or extend the LED service life, or both.

FIG. 2 illustrates another GU10 lamp which in this example is dimmable. A similar numbering system to that used in FIG. 1 has been adopted. The control circuitry and the additional circuitry required for the dimming function are now contained on a composite PCB 48, again housed within the GU10 cap 49. The IC board 48 has two parts, comprising a glass-reinforced epoxy laminate board 57 (e.g. a PCB made from FR-4) and a MCPCB 55 mounted substantially at right angles to the PCB 57. The MCPCB 55 carries the main control IC 56, which has a greater heat output when it includes a dimming function, and thus is preferably mounted on a MCPCB. These two boards may be connected by way of soldered connections or more preferably by a plug-in arrangement. As with the previous example the dual IC board 48 is fully potted within the GU10 cap and a layer of insulating material 47 provides further thermal separation from the heat sink body 46.

The arrangement of PCBs shown in FIG. 2 where board 55 is substantially perpendicular to board 57 is only one of many possible arrangements. For example, the smaller board 55 be positioned over board 57 in a sandwich type arrangement.

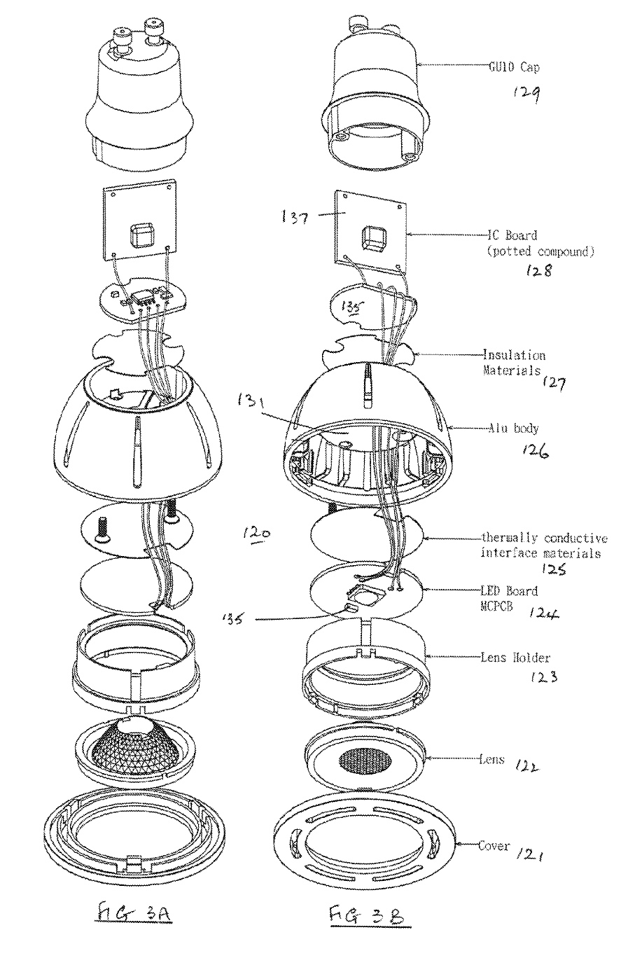

FIGS. 3A and 3B and 4A and 4B illustrate further arrangements by which all of the necessary electrical/electronic components other than the LED itself can be housed away from and thermally isolated from the LED PCB, and within the GU10 cap. Once again a similar numbering system to that in FIG. 1 has been adopted. As with the example shown in FIG. 2, both these examples involve splitting the components between two separate PCBs. In these examples one of the two IC PCBs 95, 135 is substantially circular and sits on a layer of insulating material 87, 127 on the rear face of the rear wall of the body 91, 131. This PCB is connected by four wires to the LED PCB. A further PCB 97, 137 is located up inside the GU10 cap 89, 129 and connected to the PCBs 95, 135 respectively by wire connections.

These PCB's can be formed from any suitable material, or combination of materials such as FR-4 or a MCPCB as dictated by the respective component heat outputs. Once again these PCB combinations are fully potted inside the respective GU10 caps. This is most easily achieved by injecting the potting compound through the GU10 cap once the module is assembled.

The examples shown in FIGS. 3 and 4 lend themselves to an alternative form of construction. In this alternative, not shown, the lower PCB 95′, 135′ is a MCPCB and the layer of material between the MCPCB and the module body 86′, 126′ is a thermally conductive interface layer 87′, 127′ rather than a thermal insulator. In this example the outer surface of the rear end wall 91′, 131′ of the module body is preferably substantially flat and planar, to encourage good heat transfer into the heat sink. In this way, heat generated by the components on PCB's 95′, 135′ can be dissipated by the heat sink.

This invention is particularly applicable to the latest type of ‘smart’ LED lamps and luminaires that contain detectors that sense information about their local environment and which communicate this information to a processor. These luminaires offer a way of collecting data about the environment in which they are situated. This overcomes the problems associated with dedicated sensors in a particular location, such as a thermostat which only covers a limited area, because a building or house will typically contain many luminaires, each potentially capable of gathering data. The data gathered by ‘smart’ luminaires thus has a much higher granularity than data collected by other approaches, and is therefore more useful. However this brings with it the need for much greater data gathering/storing and data processing capability in ‘smart’ luminaires than in conventional LED lamps, as well as the need to pass on this data by wireless or by power-line communication (PLC). This requirement can have a significant impact on the amount of heat produced by the onboard control IC chip(s) or other electronic circuitry. The present compromising the life of the LED light engine(s) and without the need for larger heat sinks.

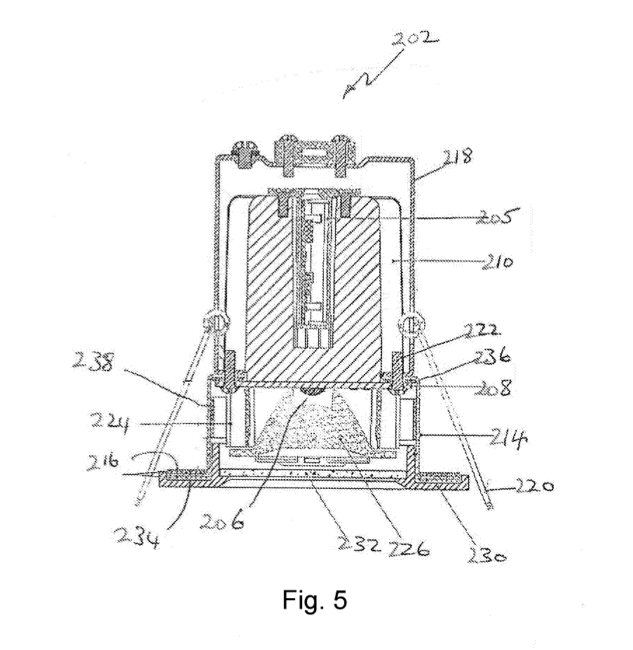

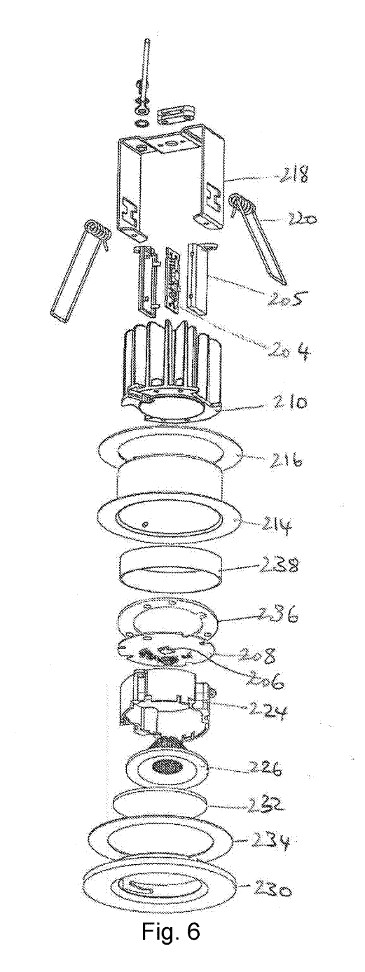

Whilst the examples described are of GU10-type lamps, this technology can be adopted in any type of lamp or luminaire in which there is space behind or away from the LED PCB to accommodate a second PCB or second PCB assembly. For example, referring to FIGS. 5 and 6, there can be seen an embodiment in which the technology of the present invention is incorporated into a fire rated downlight assembly, fixture or unit 202. The downlight unit 202 comprises a light source 206 in the form of an LED light engine mounted to a printed circuit board 208, forming an LED module. In this example the circuit board is of a material having a relatively low melting point (in comparison to the fire rating test temperature) for example an aluminium or coated aluminium circuit board. The melting point of aluminium is around 660 degrees C., well below the temperature at which fire rating tests are performed.

Within the context of the present application, the reference to a melting point is a reference to the temperature at which the structural integrity of the circuit board can no longer be maintained. In the case of a metal circuit board, this is the melting point, but in the case of a ceramic circuit board, the meaning will readily be apparent to one skilled in the art.

The downlight unit further comprises a heat sink 210 provided to a rear side of the circuit board 208, in good thermal contact with it, and a lens arrangement located at a front side of the circuit board.

The circuit board 208 and the heat sink 210 are physically, though not thermally, connected by way of a cylindrical casing or mounting ring 214 as described below. The circuit board is manufactured to have good thermal conductivity properties, for example from a material inherently having such properties or treated to have such properties. This allows for heat generated by the LED Light engine to pass efficiently to the heat sink.

The term “cylindrical casing” means conforming approximately to the shape of a hollow cylinder. It will be understood that a misshapen cylinder will work equally well. Similarly, while the embodiments show a generally circular cylindrical tubular body other sections may be used with amendment to the sectional shape of other components.

The heat sink 210 is formed from any suitable material, preferably cast or extruded aluminium. The heat sink 210 comprises at a lower end an outer annular portion for location against an upper portion of the cylindrical casing. The annular portion surrounds an end face of the heat sink. In the illustrated embodiment the end face is proud of the annular portion.

The cylindrical casing or mounting ring 214 comprises a side wall having a lower peripheral annular flange extending outwardly from a bottom end of the side wall to form a front face and an upper peripheral annular flange extending inwardly from an upper end of the side wall to form a rear face having an opening. The mounting ring 214 is formed from any suitable material, preferably steel. It will be understood that the melting point of steel is typically above the temperature used for fire rating tests and a suitable steel will be chosen with this in mind.

The upper peripheral flange locates against the annular portion of the heat sink 210 and surrounds the end face of the heat sink. It can be seen that in this way the heat sink closes the mounting ring from the rear.

A bracket 218 having depending legs and a central portion is provided in which spring biased members or clips 220 are mounted on each of the legs. Feet at the free ends of the legs are secured to the mounting ring 214.

Other electrical/electronic components required for operation of the LED lighting module such as a driver 204 and other control circuitry components are mounted on a second PCB or PCB assembly within a so-called driver box 205, in turn located within a void or recess in the heat sink 210. The driver box 5 is provided with flanges by which the driver box 5 may be secured to an upper part of the heat sink 210 or the bracket 218 by any suitable means whilst maintaining good thermal insulation between the second PCB and the heat sink. It will be appreciated that this is not the only possible location for the driver box, which could be located away from the heat sink in some suitable location, such as mounted on the bracket 218.

The heat sink 210 is mounted on the mounting ring 214 with a front face of the heat sink 210 extending through the upper annular flange of the mounting ring 214 to close the opening at the rear of the mounting ring 214.

A first ring or washer 216 of silicone is provided on the lower peripheral flange of the mounting ring 214. In practice, this ring or washer 216 of silicone provides a relatively airtight seal between the lower peripheral flange of the mounting ring 214 and a rim of a ceiling aperture into which the downlight fixture is fitted. This seal also server to prevent water or other moisture, such as steam, from passing from a room into the space behind the ceiling.

The circuit board 208 is secured to the heat sink 210 by fasteners 222 extending through the mounting ring 214, such that the end face of the heat sink 210 is held in thermal contact with a substantial part of the rear surface of the circuit board 208. A periphery of the rear surface of the circuit board extends radially beyond the heat sink.

The fasteners 222 also serve to secure a lens holder in position. A lens holder 224 is used to locate a lens 226 in position.

The lens holder 224 is secured in place to seat against the circuit board 208.

A glass 232 retained by a bezel 230, itself located within and by the mounting ring 214, is disposed in front of the lens 226 and lens holder 224. A second ring or washer 234 of silicone extends between the bezel 230 and the mounting ring 214. The space within the mounting ring 214 above the glass 232 defines a void within which the lens 226 is located by the lens holder 224.

The fasteners 222 extend through a ring or washer 236 of fireproof material or other non-thermally conductive material conveniently located between the periphery of the circuit board 208 and upper annular flange of the mounting ring 214. In this way the printed circuit board is kept separated from the mounting ring 214 and is not in direct contact with the mounting ring 214.

Preferably, the fireproof material of the ring or washer 236 takes the form of a ring of intumescent material.

A collar or sleeve of 238 of intumescent fireproof material is located around an upper portion of the side wall of the mounting ring 214. Preferably, the fireproof material takes the form of a continuous sleeve of intumescent material. However, a discontinuous sleeve of intumescent material may be used instead.

The sleeve is of sufficient dimension that upon expansion due to heat, the intumescent fireproof material expands to form a fireproof barrier. It will be understood that any suitable arrangement whether a continuous sleeve or a discontinuous sleeve can be selected to achieve the desired fire rating.

In this embodiment, it can be seen that the sleeve 238 covers around half of the internal surface of the tubular body of the mounting ring 214. An upper edge is located below the ends of the fasteners depending into the void. A lower edge of the sleeve 238 is located above the bezel 230 where the bezel 230 extends, in use, into the tubular body of the mounting ring.

In normal use, the heat generated by the solid state lighting unit is taken from the circuit board and dissipated via the heat sink 210. In this way the heat within the void is not sufficient to trigger expansion of the fireproof intumescent material.

However, in the event of a fire the greater temperatures to which the fireproof material is then subjected to, will cause it to expand and fill the void with a barrier having fire resistant properties. This in turn protects the circuit board from damage by such temperatures allowing the structural integrity of the downlight assembly to be maintained for the duration of the fire rating test.

Accordingly, the combination of a low melting point circuit board, which allows for efficient direct conduction of heat from the lighting unit to the heat sink, as well as thermally isolating the second control PBC from the heat sink, together with the sleeve of intumescent fireproof material which is only triggered on exposure to higher levels of heat than are normally present, enables the production of an improved fire rated downlight fixture utilising solid state technology with much improved service life. The space within the void inside the heat sink 210 is more than sufficient to accommodate all the power, control, dimming, communication and processing circuitry and components necessary for the operation of a ‘smart’ luminaire.

1. An LED downlight lighting module comprising:
an LED module comprising one or more single LED(s) on a first printed circuit board;
a heat sink comprising a heat sink structure, wherein the first printed circuit board being in good thermal contact with the heat sink such that heat from the LED(s) on the LED module is dissipated through the heat sink; and
a second printed circuit board adapted to accommodate a power and control circuitry for the LED(s),
wherein the second printed circuit board is located within a driver box accommodated within one of a void and a recess in the heat sink structure, and wherein the driver box is thermally insulated from both the heat sink and from the first printed circuit board, and thus from the LED(s).

2. The LED downlight lighting module of claim 1, wherein the second printed circuit board further comprises a dimming circuitry for the LED(s).

3. The LED downlight lighting module of claim 1, wherein at least one of the first printed circuit board and the second printed circuit board comprises a metal printed circuit board.

4. The LED downlight lighting module of claim 3, wherein the metal printed circuit board comprises aluminum.

5. The LED downlight lighting module of claim 1, further comprising a thermally conductive interface between the first printed circuit board and the heat sink.

6. The LED downlight lighting module of claim 5, wherein the thermally conductive interface comprises one of a thermally conductive grease and a thermally conducting pad.

7. The LED downlight lighting module of claim 1, wherein the second printed circuit board comprises a glass-reinforced epoxy laminate sheet.

8.-10. (canceled)

11. The LED downlight lighting module of claim 1, wherein the heat sink comprises a body formed from a material comprising a thermally conductive material.

12. The LED downlight lighting module of claim 11, wherein the thermally conductive material comprises aluminum.

13.-16. (canceled)

17. The LED downlight lighting module of claim 11, wherein the body comprises a plurality of fins.

18.-25. (canceled)

26. The LED downlight lighting module of claim 1, further comprising a lens.

27. The LED downlight lighting module of claim 26, further comprising a lens cover.

28.-29. (canceled)

30. An LED downlight lighting module comprising:
an LED module comprising one or more single LED(s) on a first printed circuit board;
a heat sink comprising a substantially hollow body, the substantially hollow body comprising a plurality of fins arranged within the substantially hollow body, wherein the substantially hollow body and the fins are formed from a material comprising a thermally conductive material and the first printed circuit board is in good thermal contact with the substantially hollow body such that heat from the LED(s) is dissipated through both the substantially hollow body and the fins; and
a second printed circuit board adapted to accommodate a power and control circuitry for the LED(s),
wherein the second printed circuit board is located within a driver box accommodated within one of a void and a recess in the substantially hollow body, and wherein the driver box is thermally insulated from the substantially hollow body of the heat sink and from the first printed circuit board, and thus from the LED(s).

31. The LED downlight lighting module of claim 30, further comprising a lamp cap fitting.

32. The LED downlight lighting module of claim 31, wherein the lamp cap fitting comprises a GU10 fitting.

33. The LED downlight lighting module of claim 32, wherein the second printed circuit board is accommodated within the GU10 fitting.

34. The LED downlight lighting module of claim 30, wherein the second printed circuit board further comprises a dimming circuitry for the LED(s).

35. The LED downlight lighting module of claim 30, wherein at least one of the first printed circuit board and the second printed circuit board comprises a metal printed circuit board.

36. The LED downlight lighting module of claim 30, wherein the substantially hollow body takes the form of a substantially frustoconical shape closed at or near its narrower end by a rear wall having a front face and a rear face.

37. An LED light fitting comprising:
an LED downlight lighting module comprising:
an LED module comprising one or more single LED(s) on a first printed circuit board;
a heat sink comprising a heat sink structure, wherein the first printed circuit board is in good thermal contact with the heat sink such that heat from the LED(s) is dissipated through the heat sink; and
a second printed circuit board adapted to accommodate a power and control circuitry for the LED(s),
wherein the second printed circuit board is located within a driver box accommodated within one of a void and a recess in the heat sink structure, and wherein the driver box is thermally insulated from both the heat sink and from the first printed circuit board, and thus from the LED(s).
